(19) United States
(12) Patent Application Publication
(10) Pub. No.: US 2005/0031500 A1
(43) Pub. Date: Feb. 10, 2005

(54) Semiconductor waste gas processing device with flame path

(76) Inventor: Wu Niang Feng, Chu-Pei (TW)

Correspondence Address: N/A, N/A, Alexandria, VA, 22313-1450, US

(21) Appl. No.: 10/634,697

(22) Filed: Aug. 6, 2003

(51) Int. Cl. B01D 53/34; B01D 50/00

(52) U.S. Cl. 422/168

(57) ABSTRACT

A semiconductor waste gas processing device comprises a flame path through a waste gas combustion chamber, a head section on a top of the waste gas combustion chamber, and a waste gases outlet. The flame path comprises at least one layer of fuel spray ring; each fuel spray ring having a respective fuel room formed in the head section and being connected to a fuel source line for supplying fuel gas; a secondary flame ring of each fuel spray ring having a plurality of secondary flame apertures; a tapered flame jet which is communicable with the waste gas combustion chamber being formed in a lower end of the flame path and an igniter being installed in the flame path.

### FIELD OF THE INVENTION

The present invention relates to waste gas processing devices, and particularly to a semiconductor waste gas processing device with a flame path for cleaning waste gas effectively and preventing the inside of body from erosion.

### BACKGROUND OF THE INVENTION

In the semiconductor manufacturing process, waste gas contains fluorine gas with strong erosion. The ions of the gas must be decomposed under a high temperature of 1000° C. so as to form harmless gases. In the prior art, fuel gas is injected into a waste gas combustion chamber from a head section. The fuel is fired in an outlet of the head section so that a high temperature flame is formed in the waste gas combustion chamber for thermally decomposing the fluorine ions into harmless gas. Thereby, the waste gas is cleaned.

The flame is low density flame and the waste gas can pass through the gaps between the flame. The firing area is only confined at the outlet of the waste gas combustion chamber so that not all waste gas is cleaned.

Moreover, after the high temperature is burnt, the combustible harmful material will become ash which will adhere on the inner side of body. After a long time, a thick ash layer is formed so that the waste gas combustion chamber can not be operated normally.

Moreover, the high temperature is as high as 600° C. The fluorine ions in the waste gas have a high erosion at this temperature so as to damage the inner side of body when the waste gas combustion chamber is used for a longer time.

### SUMMARY OF THE INVENTION

Accordingly, the primary object of the present invention is to provide a semiconductor waste gas processing device with a flame path for cleaning waste gas effectively and preventing inner side of body from erosion.

To achieve above objects, the present invention provides a semiconductor waste gas processing device which comprises a flame path through a waste gas combustion chamber, a head section on a top of the waste gas combustion chamber, and a waste gases outlet. The flame path comprises at least one layer of fuel spray ring. Each fuel spray ring has a respective fuel room formed in the head section and is connected to a fuel source line for supplying fuel gas. A secondary flame ring of each fuel spray ring has a plurality of secondary flame apertures. A tapered flame jet is communicable with the waste gas combustion chamber and is formed in a lower end of the flame path and an igniter is installed in the flame path.

The various objects and advantages of the present invention will be more readily understood from the following detailed description when read in conjunction with the appended drawing.

### BRIEF DESCRIPTION OF THE DRAWINGS

FIG. 1 is an upper view of a head section of the present invention which is located on the top of a waste gas combustion chamber.

FIG. 2 is a cross section view along A-A of the first embodiment of the present invention.

FIG. 3 is a cross section view about the second embodiment of the present invention.

FIG. 3(a) is a partial enlarged view of FIG. 3.

FIG. 4 is a cross section view showing the third embodiment of the present invention.

FIG. 5 is a cross section view showing the fourth embodiment of the present invention.

FIG. 6 is a cross section view showing the application of the fourth embodiment of the present invention.

FIG. 7 is a cross section view showing the fifth embodiment of the present invention.

### DETAILED DESCRIPTION OF THE PREFERRED EMBODIMENTS

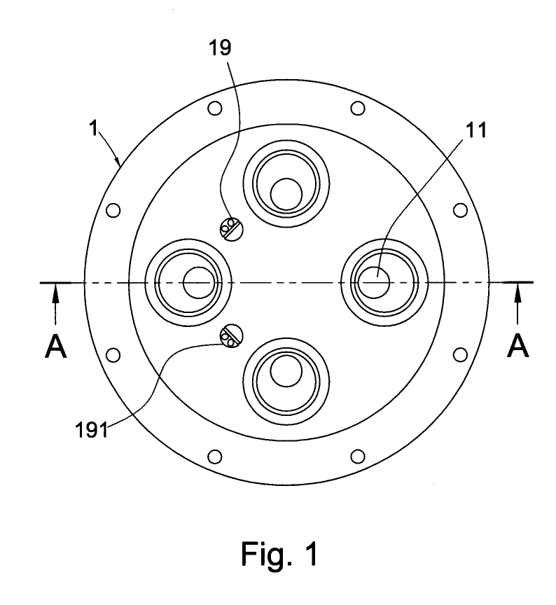

To cause those skilled in the art can understand the present invention in detail, the first to fifth embodiments of the present invention will be described hereafter with the appended FIGS. 1 to 7.

First Embodiment

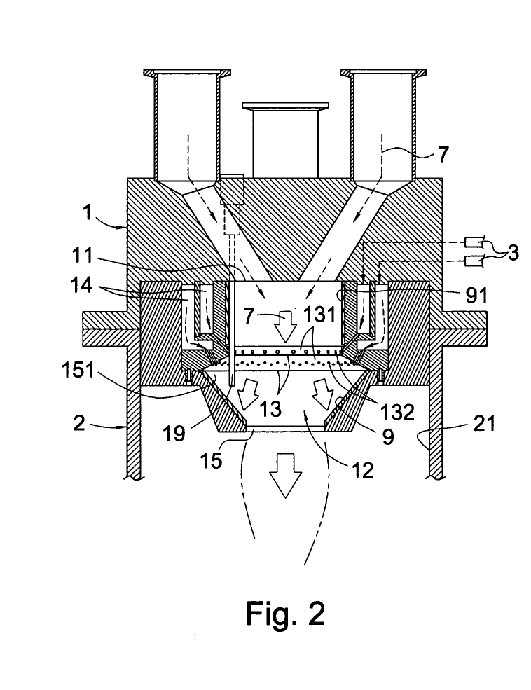

FIGS. 1 and 2 show a semiconductor waste gas processing device with a flame path of the present invention. The device includes a flame path 12 passing through the waste gas combustion chamber 2, a head section 1 located on a top of the waste gas combustion chamber 2, and a waste gases outlet 11.

The flame path 12 is formed by at least one layer of fuel spray ring 13. The fuel spray ring 13 is installed with a plurality of secondary flame apertures 132. A secondary flame ring 131 of each fuel spray ring 13 has a plurality of secondary flame apertures 132. The shapes of the secondary flame ring 131 and the plurality of secondary flame apertures 132 may be plane shapes or tapered shapes. A lower end of the flame path 12 is formed with a flame jet 15 which is communicable with the waste gas combustion chamber 2. An internal of the flame jet 15 is formed with a flame capture area 151 which can retain a flame even a large amount of waste gas exists. An igniter 19 and a temperature probe 191 of oxidization-proof and erosion-proof are installed in the flame path 12. Moreover, an inner wall of the flame path-12 is coated with ceramic (Al₂O₃ 99.5%) 9, 91.

At least one fuel room 14 the number of which is equal to that of the fuel spray ring 13 is formed in the head section 1 (referring to FIG. 2). A fuel source line 3 is connected to the fuel room 14 for supplying fuel gas. A plurality of fuel rooms 14 are annularly arranged around a periphery of the flame path 12.

In realization, the igniter 19 fires the fuel gas jetted out from the fuel spray ring 13 (referring to FIGS. 1 and 2). Then, the temperature probe 191 detects the fire temperature. Then at least one layer of high density fire net is formed in the flame path 12. Then fire net is concentrated as a strong flame. The strong flame is jetted into the waste gas combustion chamber 2 from the flame jet 15. Then waste gas 7 flows into the flame path 12 from the waste gases outlet 11 so that the waste gas 7 can be concentrated in the flame path 12. By the strong flame of the high density fire net, the waste gas 7 can be cleaned before entering in into the waste gas combustion chamber 2.

Second Embodiment:

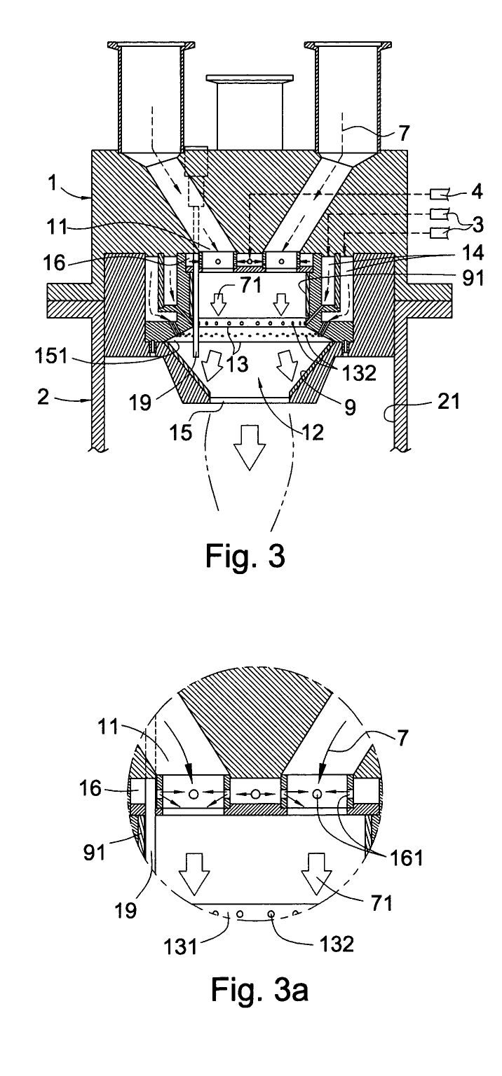

In the present invention, a plurality of oxygen apertures 161 can be formed at the plurality of waste gases outlets 11 (referring to FIGS. 3 and 3(a)) so that one end of each oxygen aperture 161 is communicable to the respective waste gases outlet 11 and another end of the oxygen aperture 161 is communicable with one oxygen (or fuel) room 16. A oxygen source line 4 is connected to the flame path 12 for supplying pure oxygen (or fuel gas) so that the waste gas 7 can mix with the pure oxygen (or fuel gas) so as to form as gas mixing room 71. By containing oxygen or fuel gas in the waste gases outlet 11, when the waste gas 7 flows through the fire nets, the harmful materials in the waste gas 7 will be burnt out or cleaned.

Third Embodiment

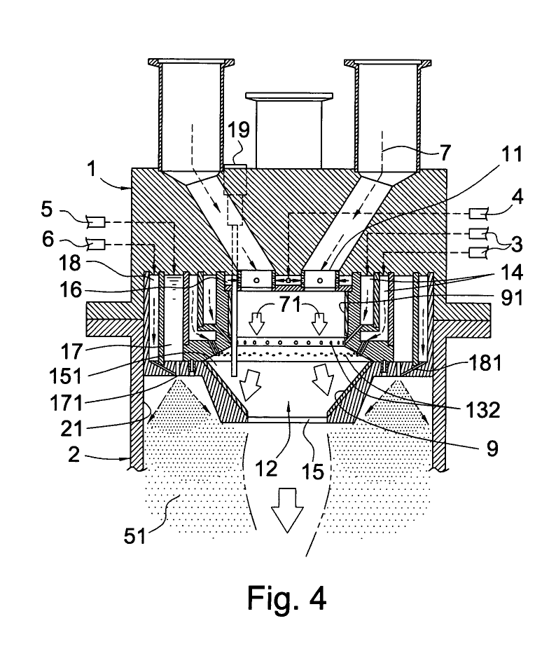

In the present invention, an annular water room 17 (referring to FIG. 4) is formed in the periphery of the fuel room 14 in the head section 1. A water source line 5 for supplying high pressure water flow is connected to the water room 17. A bottom of the water room 17 is installed with a plurality of water spray apertures 171 so that the plurality of water spray apertures 171 is communicable to the waste gas combustion chamber 2. Moreover, a periphery of the water room 17 is formed with an annular air room 18 (referring to FIG. 4). A high pressure air source line 6 is connected to the air room 18 for supplying high pressure air. A bottom of the air room 18 is formed with a plurality of air spray apertures 181 which are aligned to the outlet of the water spray aperture 171 to be communicable to the waste gas combustion chamber 2. By above structure, the high pressure water flow injecting into the waste gas combustion chamber 2 from the water spray apertures 171 is dispersed as moisture 51 by the high pressure air spraying out from the air spray apertures 181. Then fluorine ions remaining in the waste gas 7 converts into hydrogen-fluoride acid for avoiding erode the inside of body 21 of the waste gas combustion chamber 2. Besides, the moisture 51 can be combined with ashes in the waste gases 7 to be condensed as water drops to clean ashes from the combustion of the waste gases 7 for avoiding the ashes to pollute the inside of body 21.

Fourth Embodiment

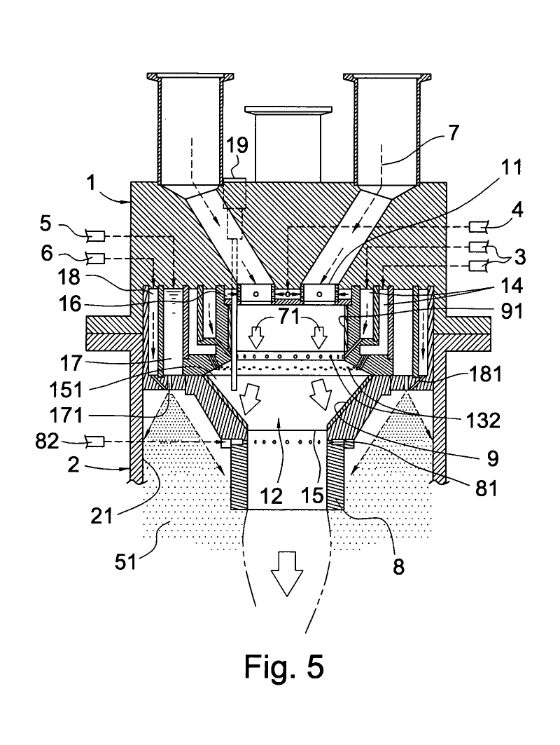

In the present invention, the flame jet 15 of the head section 1 is installed with a flame room 8 (referring to FIG. 5). A plurality of fire jetting sleeve 8 is formed with a plurality of flame apertures 81 which are connected to respective fuel source line 82 for receiving fuel gas. By above structure, the flame apertures 81 can jet out fuel gas as a fire net for cleaning the waste gases again.

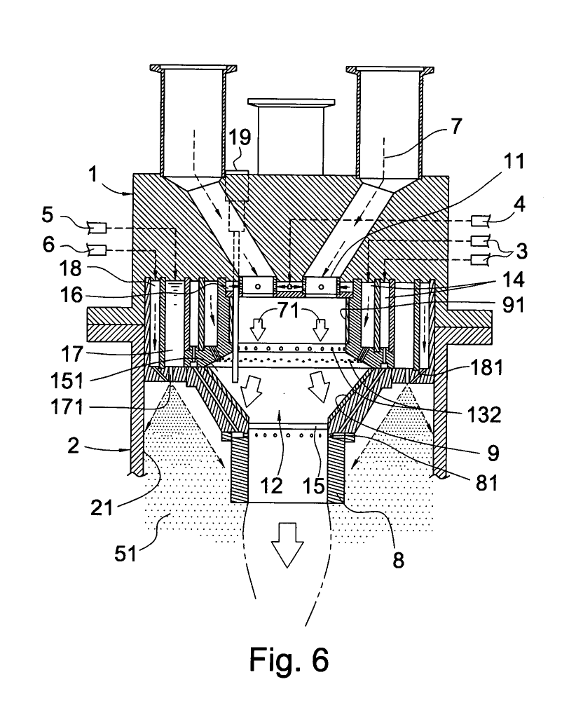

Besides, each of the plurality of flame apertures 81 in the fire jetting sleeve 8 has a fuel gas channel 82 which is communicable to the fuel room 14 (referring to FIG. 6) so that fuel gas is supplied from the fuel room 14 without using any fuel source line 82.

Referring to FIGS. 2, 3, and 5, the fuel gas used in the fuel room 14 of above mentioned embodiments can be selected from gas (such as methane, propane and butane) or hydrogen, etc. It can be determined by the user. Furthermore, in the oxygen (or fuel) room 16 of the second embodiment (referring to FIGS. 3 and 3(a)), before the waste gases 7 pass through the fire net, it is fully mixed with the waste gases 7 to completely clean the waste gases 7.

Fifth Embodiment

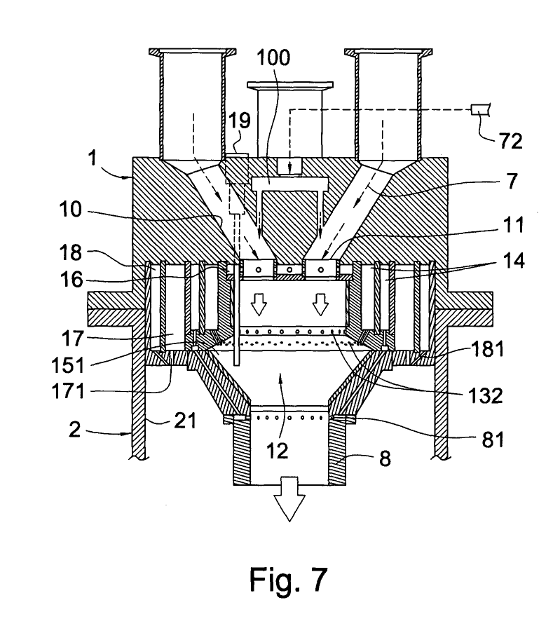

In this embodiment, the center of the head section 1 in above said embodiments is formed with a nitrogen path 100 (referring to FIG. 7). An inlet thereof is connected to a nitrogen source line 72 and an outlet thereof is inserted into a waste gases path 10 at an upper edge of the waste gases outlet 11. Thereby, when the flames of the flame apertures 81 and secondary flame apertures 132 are distinguished, the nitrogen flow is divided into each waste gases path 10. This is beneficial for mixing and dilution of the waste gases generated in the waste gases path 10 of semiconductor manufacturing process (SiH₄ and NF₃, Cl₂, HCl). Thereby, explosion is avoided.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A semiconductor waste gas processing device comprising:
a flame path through a waste gas combustion chamber, a head section on a top of the waste gas combustion chamber, and a waste gases outlet; the flame path further comprising:
at least one fuel spray ring; each fuel spray ring having a respective fuel room formed in the head section and being connected to a fuel source line for supplying fuel gas; a secondary flame ring of each fuel spray ring having a plurality of secondary flame apertures;
a tapered flame jet which is communicable with the waste gas combustion chamber being formed in a lower end of the flame path, and
an igniter being installed in the flame path.

2. The semiconductor waste gas processing device with a flame path as claimed in claim 1, wherein a plurality of pure oxygen outlet holes are formed in the waste gases outlet.

3. The semiconductor waste gas processing device with a flame path as claimed in claim 1, wherein the secondary flame ring and the plurality of secondary flame apertures have plane shapes or tapered shapes.

4. The semiconductor waste gas processing device with a flame path as claimed in claim 1, wherein an internal of the flame jet is formed with a flame capture area.

5. The semiconductor waste gas processing device with a flame path as claimed in claim 1, wherein an annular water room is formed in the periphery of the fuel room in the head section; and a bottom of the water room is installed with a plurality of water spray apertures so that the plurality of water spray apertures are communicable to the waste gas combustion chamber.

6. The semiconductor waste gas processing device with a flame path as claimed in claim 5, wherein a periphery of the water room is formed with an annular air room; a bottom of the air room is formed with a plurality of air spray apertures which are aligned to the outlet of the water spray aperture for communicating with the waste gas combustion chamber.

7. The semiconductor waste gas processing device with a flame path as claimed in claim 1, a flame jet of the head section is installed with a fire jetting sleeve.

8. The semiconductor waste gas processing device with a flame path as claimed in claim 7, wherein the fire jetting sleeve is formed with a plurality of flame apertures which are connected to respective fuel source line for receiving fuel gas.

9. The semiconductor waste gas processing device with a flame path as claimed in claim 7, wherein the fire jetting sleeve is formed with a plurality of flame apertures which are connected to respective fuel source line; and the fuel source line is communicated to the fuel room for receiving fuel gas.

10. The semiconductor waste gas processing device with a flame path as claimed in claim 1, wherein a center of the head section is formed with a nitrogen path; an inlet of the nitrogen path is connected to a nitrogen source line and an outlet thereof is inserted into a waste gases path at an upper edge of the waste gases outlet.

11. The semiconductor waste gas processing device with a flame path as claimed in claim 1, wherein a temperature probe is installed in the flame path.
